(19) United States
(12) Patent Application Publication
(10) Pub. No.: US 2006/0104079 A1
(43) Pub. Date: May 18, 2006

(54) Illuminating device that casts light in various directions

(75) Inventors: Chien-Shun Chen, Douliou City (TW); Wen-Wen Lin, Dounan Township (TW)

Correspondence Address: GENUS LAW GROUP;LOWE HAUPTMAN & BERNER, LLP, 1700 DIAGONAL ROAD, SUITE 300, ALEXANDRIA, VA, 22314, US

(73) Assignee: BAYCOM OPTO-ELECTRONICS TECHNOLOGY CO., LTD.

(21) Appl. No.: 10/986,845

(22) Filed: Nov. 15, 2004

(51) Int. Cl. G02B 6/04

(52) U.S. Cl. 362/554

(57) ABSTRACT

The present invention provides an illuminating device that casts light in various directions and can be hung on an instrument. The illuminating device includes a bundle of at least one plastic optical fiber and at least one fastener. In use, the bundle is hung on the instrument because of the fastener. The bundle is connected with a light source at an end and can be directed in various directions at an opposite end because of the flexibility of the bundle in order to provide an optimal illuminative effect.

### BACKGROUND OF THE INVENTION

1. Field of the Invention

The present invention relates to an illuminating device that casts light in various directions. The illuminating device includes a plastic optical fiber and fasteners. In use, the fasteners enable the illuminating device to be hung on an instrument such as dental devices. The plastic optical fiber includes an end connected with a light source and a flexible opposite end that can be directed in various directions in order to cast light in any desired direction in order to provide an optimal illuminative effect.

2. Description of the Related Art

In general, a dental device such as a dental mirror and a dental drill must be inserted into a patient's mouth. Therefore, an illuminating device must be used together with the dental device so that medical treatment can be conducted. Conventional illuminating devices are attached to chairs on which patients sit or provided above beds in which patients lie. Although the positions of the conventional illuminating devices can be changed, they are still often hindered by doctors' heads or hands so that they cannot cast light to the patients.

There have been conventional medical devices in which optical fibers and illuminating devices are used. They improve conditions under which patients are observed. However, most of the optical fibers are glass optical fibers. The flexibility of glass optical fibers is poor so that a glass optical fiber can easily be broken when it is more than 100 mm in diameter. Instead, a bundle of thinner glass optical fibers is used, but it still needs a lens for coupling the glass optical fibers and a light source. This however increases the cost. When an illuminating device is built in a medical device, the illuminating device is restrained to cast light in a fixed direction based on the medical device. When medical objects change or serious wounds are deformed, the illuminating device might be of little use. Moreover, as the illuminating device is built in the medical device, a user cannot replace used optical fibers with new optical fibers. Even when only the optical fibers are broken, a user has to send the whole medical device to a repair shop. This causes inconvenience for the user.

Therefore, there is a need for an illuminating device that casts light in various directions and can be hung on an instrument. The illuminating device can be curbed under different conditions in order to provide an optimal illuminative effect. Moreover, because the illuminating device is hung on the instrument, when optical fibers are broken or just because of his or her preference, a user can replace the illuminating device with a new one without the need of sending it to a repair shop or the help from any other professional.

### SUMMARY OF THE INVENTION

The primary objective of the present invention is to provide an illuminating device that casts light in various directions and can be hung on an instrument. According to various medical objects or conditions, the illuminating device casts light in various directions so that a medical process goes smoothly.

To achieve the foregoing objective, the present invention provides an illuminating device that includes a bundle of at least one plastic optical fiber and at least one fastener. The bundle is connected with a light source at an end. The fastener attaches the bundle to a pre-determined medical instrument.

The illuminating device that casts light in various directions according to the present invention takes the advantages of the flexibility of plastic optical fibers and the property that they can focus light at an end. Besides, because the plastic optical fibers have a better light-transmitting efficiency within the wavelength range of the visible light, the lens is unnecessary and the cost can also be reduced; moreover, the plastic fibers is almost rotationally symmetric arrangement, which optimizes the light-source coupling efficiency. When the illuminating device is in use, the bundle is hung on the medical instrument so that the bundle can be directed in various directions in order to provide the optimal illuminative effect. Since the illuminating device is hung on the medical instrument, when the plastic optical fibers are broken or just to reduce the cost of sanitation, a user can replace the plastic optical fibers with new ones without the need of sending it to a repair shop or the help from any other professional.

### BRIEF DESCRIPTION OF THE DRAWINGS

FIG. 1 is a side view of an illuminating device that casts light in various directions according to a first embodiment of the present invention;

FIGS. 2A to 2C show the flexibility of a plastic optical fiber used in the illuminating device shown in FIG. 1;

FIG. 3A is a cross-sectional view of an illuminating device that casts light in various directions according to a first embodiment of the present invention;

FIG. 3B is an another cross-sectional view of an illuminating device that casts light in various directions according to a first embodiment of the present invention;

FIG. 4 is a side view of an illuminating device that casts light in various directions according to a second embodiment of the present invention;

FIG. 5 is a perspective view of a first dental device using the illuminating device according to the present invention; and

FIG. 6 is a perspective view of a second dental device using the illuminating device according to the present invention.

### DETAILED DESCRIPTION OF PREFERRED EMBODIMENT OF THE INVENTION

### First Embodiment

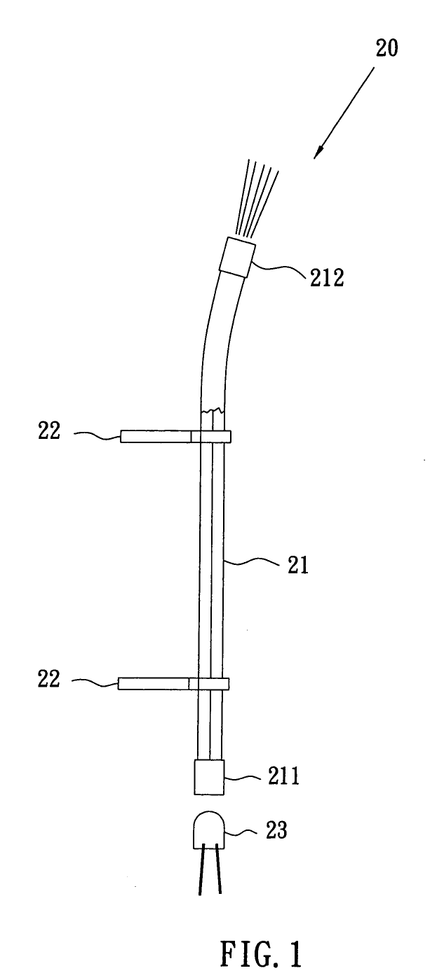

Referring to FIG. 1, according to a first embodiment of the present invention, an illuminating device 20 that is adjustable in angle includes a plastic optical fiber 21 and at least one fastener 22. The plastic optical fiber 21 includes a light-receiving end 211 connected with a light source 23. Light emitted from the light source 23 is directed by means of the plastic optical fiber 21. The light is emitted from a light-emitting end 212 of the plastic optical fiber 21 in order to provide brightness of illumination that is needed. Moreover, the plastic optical fiber 21 is preferably a flexible end-light plastic optical made of materials such as poly methyl methacrylate that can efficiently direct the light and focus the light at the light-emitting end 212. In addition, the plastic optical fibers have a better light-transmitting efficiency within the wavelength range of the visible light, the lens is unnecessary and the cost can also be reduced.

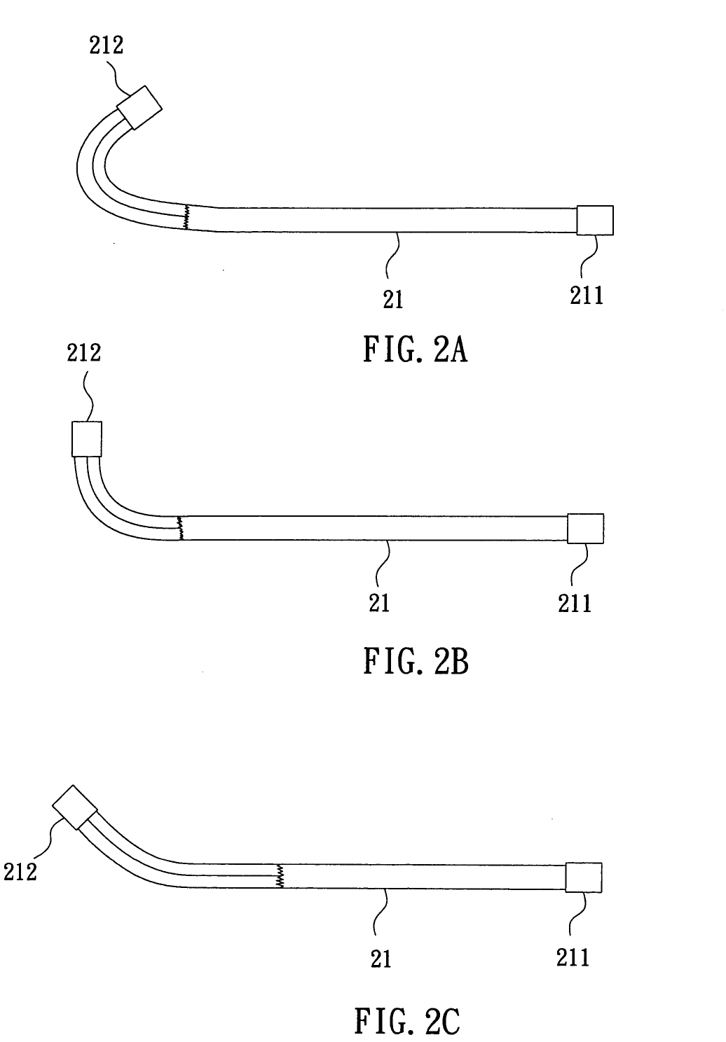

Referring to FIGS. 2A to 2C, the plastic optical fiber is flexible so that it casts light in various directions. Particularly, the light-emitting end 212 casts light in various directions, depending on brightness needed for different objects or in different environments. That is, the curvature of the light-emitting end 212 can be modified adequately in order to achieve an optimal illuminative effect.

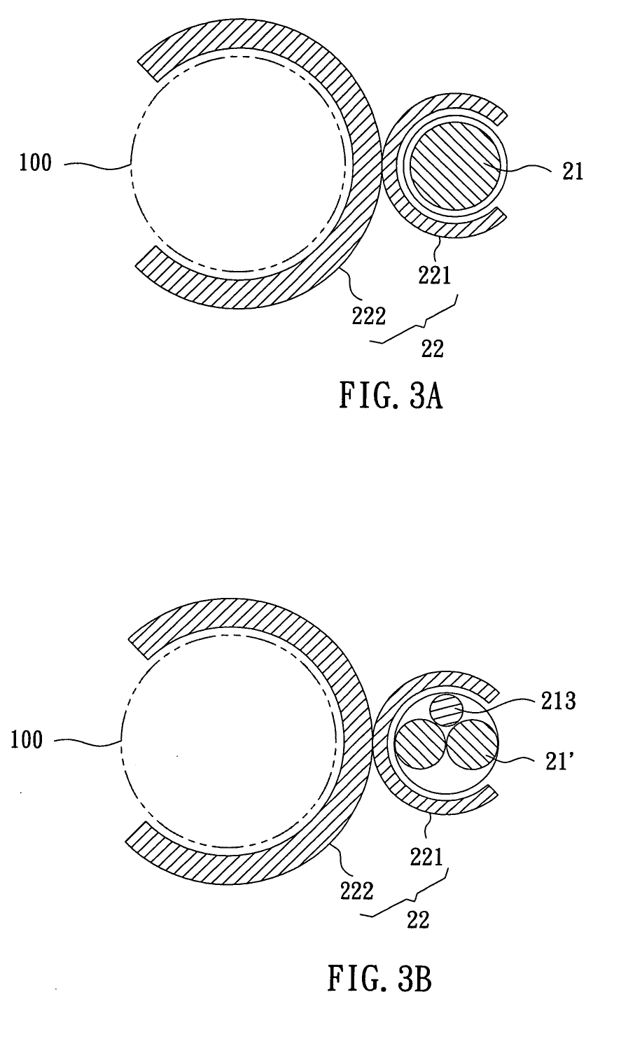

Referring to FIG. 3A, the fastener 22 of the illuminating device 20 includes a first clipping portion 221 and a second clipping portion 222. The first clipping portion 221 is a C-clip for clipping the plastic optical fiber 21. The second clipping portion 222 is also a reverse C-clip for clipping a medical device 100 shown in phantom lines. The size of the second clipping portion 222 is determined in compliance with the size of the medical device 100. The fastener 22 of the illuminating device 20 is made of an elastic material. Hence, the plastic optical fiber 21 can be mounted or removed easily.

Referring to FIG. 3B, at least two slender plastic optical fibers 21′ are used instead of the single thick plastic optical fiber 21 used in the first embodiment. Using the design of multiple plastic optical fibers, a fastener must be used for wrapping the plastic optical fibers. One purpose is to avoid fibers scattered, another one is to let the plastic fibers have rotationally symmetric arrangement, which optimizes the light-source coupling efficiency. The slender plastic optical fibers 21′ are thinner and therefore more flexible in use. Hence, a support wire 213 must be used in order to retain the slender plastic optical fibers 21′ in shape. Thus, the direction in which the light is emitted is retained. The support wire 213 may be made of metal. To avoid rust problem, galvanized wires are popularly used.

### Second Embodiment

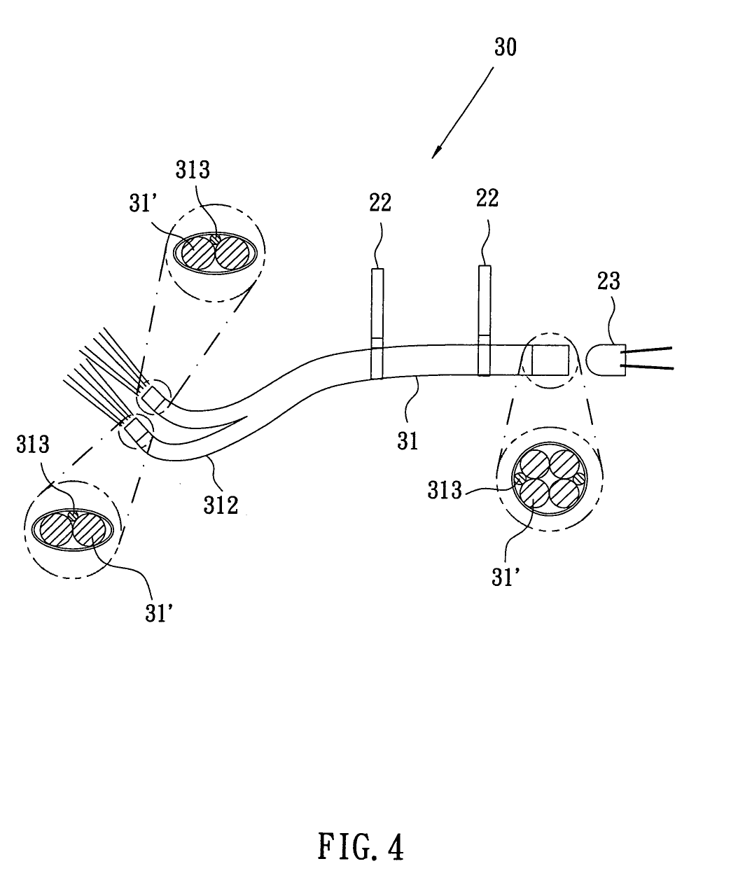

Referring to FIG. 4, according to a second embodiment of the present invention, an illuminating device 30 that casts light in various directions includes a bundle of plastic optical fibers 31 and a plurality of branches 312 extending from the bundle of plastic optical fibers 31. The number of the branches 312 is determined based on a medical device used with the illustrating device 30. The branches 312 are useful in cases where at least two light beams are needed in order to achieve an optimal illuminative effect. Each of the branches 312 includes either a proper number of plastic optical fibers 31 or a proper number of small diameter plastic optical fibers 31′ and a support wire 313 if needed.

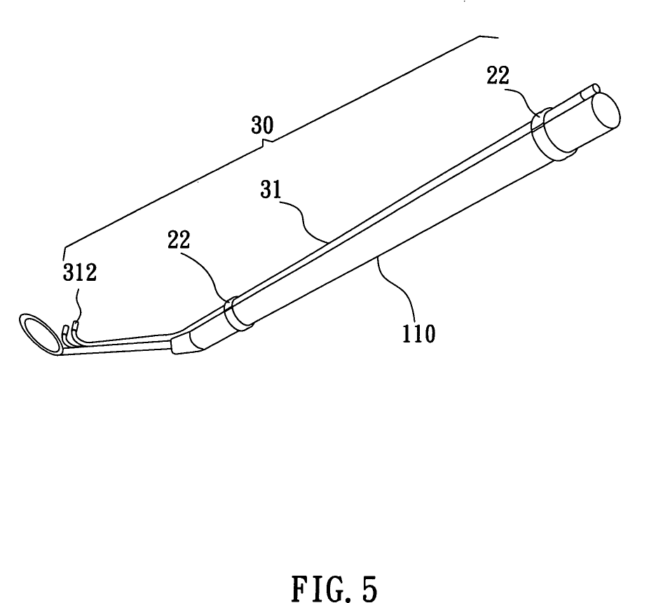

FIG. 5 shows a dental mirror 110 with which the illuminating device 30 is used. The illuminating device 30 is hung on the dental mirror 110. The fasteners 22 clip the bundle of plastic optical fibers 31 on one hand, and the dental mirror 110 on the other hand. Thus, the illuminating device 30 is kept in a proper position on the dental mirror 110. According to the position of the dental mirror 110, the branches 312 of the illuminating device 30 can be curved in order to cast two light beams. Thus, it is ensured that an object can be observed clearly.

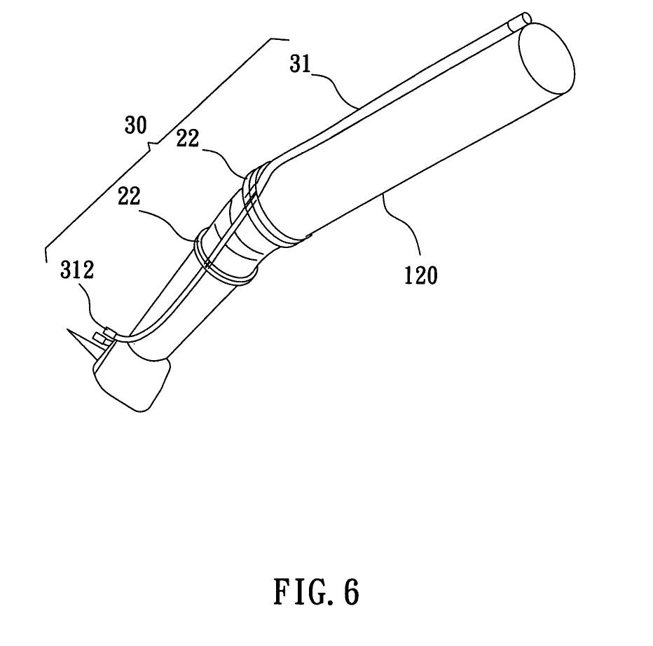

FIG. 6 shows a dental drill 120 with which the illuminating device 30 is used. The illuminating device 30 is hung on the dental drill 120. The fasteners 22 clip the bundle of plastic optical fibers 31 on one hand, and clip the dental drill 120 on the other hand. Thus, the illuminating device 30 is kept in a proper position on the dental drill 120. According to the position of the dental drill 120, the branches 312 of the illuminating device 30 can be curved in order to cast two light beams. Thus, it is ensured that an object be observed clearly.

The illuminating device 30 that casts light in various directions can be used conveniently. It can achieve an optimal illuminative effect. It can be installed conveniently. Moreover, it can reduce infection during medial processes since it can be disposed of after use since the plastic optical fibers 21, 31 are inexpensive and can be deemed consumable.

Although shown to be used with the dental mirror and the dental drill in the foregoing embodiments, the illuminating devices 20 and 30 are not limited to the cases. The present invention can be used in various cases where illumination is needed for a medical device. Moreover, the number of the plastic optical fibers is determined based on brightness required for the medical device. Hence, the number of the plastic optical fibers used in the present is not limited.

The present invention has been described via detailed illustration of three embodiments. Those skilled in the art can derive variations from the embodiments without departing from the scope of the present invention. Therefore, the embodiments shall not limit the scope of the present invention defined in the claims.

What is claimed is:

1. An illuminating device for casting light in various directions comprising
a bundle of at least one plastic optical fiber and a light source at an end of said plastic optical fiber; and
at least one fastener for attaching said plastic optical fiber to an instrument.

2. The illuminating device according to claim 1 wherein said plastic optical fiber comprises a flexible end-light plastic optical fiber.

3. The illuminating device according to claim 1 wherein said plastic optical fiber is made of poly methyl methacrylate.

4. The illuminating device according to claim 1 wherein said bundle comprises a plurality of branches.

5. The illuminating device according to claim 1 wherein said fastener comprises a first clipping portion and a second clipping portion.

6. The illuminating device according to claim 5 wherein said first clipping portion clips said bundle.

7. The illuminating device according to claim 5 wherein said second clipping portion clips said instrument.

8. The illuminating device according to claim 1 wherein said instrument comprises a dental mirror.

9. The illuminating device according to claim 1 wherein said instrument comprises a dental drill.

10. The illuminating device according to claim 1 wherein said bundle comprises small diameter plastic optical fibers.

11. The illuminating device according to claim 10 wherein said bundle further comprises at least one support wire.

12. The illuminating device according to claim 11 wherein said support wire comprises a metal wire.

13. The illuminating device according to claim 12 wherein said metal wire comprises a galvanized wire.
